(19) United States
(12) Patent Application Publication
(10) Pub. No.: US 2015/0151256 A1
(43) Pub. Date: Jun. 4, 2015

(54) MEMBRANE WITH AN ISOPOROUS, ACTIVE SEPARATION LAYER, AND METHOD FOR PRODUCING A MEMBRANE

(71) Applicant: Helmholtz-Zentrum Geesthacht Zentrum für Material- und Küstenforschung GmbH, Geesthacht (DE)

(72) Inventors: Volker Abetz, Luneburg (DE); Juliana Clodt, Hamburg (DE); M. Volkan Filiz, Hamburg (DE); Kristian Buhr, Hamburg (DE)

(73) Assignee: Helmholtz-Zentrum Geesthacht Zentrum für Material- und Küstenforschung GmbH, Geesthacht (DE)

(21) Appl. No.: 14/615,999

(22) Filed: Feb. 6, 2015

Related U.S. Application Data
(63) Continuation of application No. PCT/EP2013/001984, filed on Jul. 5, 2013.

(30) Foreign Application Priority Data
Aug. 9, 2012 (EP) 12179792.2

(51) Int. Cl. B01D 71/80; B01D 71/08; B01D 71/28; B01D 67/00

(52) U.S. Cl. CPC B01D 71/80; B01D 67/0013; B01D 71/08; B01D 71/28; B01D 2325/34

(57) ABSTRACT

The invention relates to a method for producing a polymer membrane with an isoporous, active separation layer, particularly an ultrafiltration membrane or nanofiltration membrane and to a polymer membrane produced or producible according to the invention. The method comprises the following steps: producing a casting solution having at least one solvent in which at least one amphiphilic block copolymer with at least two different polymer blocks and at least one carbohydrate are dissolved, spreading out the casting solution to form a film, allowing a part of the at least one solvent near the surface to evaporate during a waiting time, precipitating a membrane by immersing the film in a precipitation bath comprising at least one non-solvent for the block copolymer.

### CROSS REFERENCE TO RELATED APPLICATIONS

The present application is a continuation application and claims priority benefit under 35 USC §120 to PCT Patent Application No. PCT/EP2013/001984 filed on Jul. 5, 2013, which PCT application claims priority benefit to European Patent Application No. 12179792.2 filed on Aug. 9, 2012, the entireties of each of which are incorporated by reference herein.

### FIELD

The invention relates to a method for producing a polymer membrane with an isoporous, separation-active layer, especially an ultrafiltration membrane or nanofiltration membrane.

The invention further relates to a polymer membrane produced or producible by the above method, a filtration module, especially an ultrafiltration module or nanofiltration module, as well as use of a polymer membrane or a filtration module.

### BACKGROUND

Today, membranes produced according to a so-called phase inversion process are predominantly used for ultrafiltration. These membranes normally have a more or less large statistical variance during the distribution of the pore size, see S. Nunes, K.-V. Peinemann (ed.): Membrane Technology in the Chemical Industry, Wiley-VCH, Weinheim 2006, pages 23-32. Such membranes tend toward so-called fouling and do not allow precise separation of a mixture of substances due to the wide variance of the pore size distribution. Fouling is understood as rapid blocking of the large pores since a greater portion of the liquid passing through the membrane first passes through the large pores. It has thus been attempted for some time to produce isoporous membranes, i.e. membranes with a low variance in the distribution of their pore size.

In German patent no. 10 2006 045 282 by the applicant, a method is disclosed by means of which polymer membranes can be produced with isoporous separation-active surfaces. For this purpose, an amphiphilic block copolymer is dissolved in a casting solution with one or more solvents, spread into a film, and the film is immersed in a precipitation bath.

This method exploits the fact that the polymer blocks of the amphiphilic block copolymer are not miscible with each other. In the casting solution, the block copolymers do not form a micelle morphology, or only form a weak micelle morphology. Microphase separation starts upon the evaporation of the solvent, or respectively the solvent mixture, after the formation of the film and before immersion in the precipitation bath.

By immersing this film in a precipitation bath, the remainder of the solvent is displaced, and a known phase inversion process occurs which results in a known sponge-like structure. In some cases, the previously assumed microphase-separated isoporous structure of the layer close to the surface is retained despite being dipped into the precipitation bath. This layer then transitions directly into the sponge-like structure. Additional descriptions are contained in DE 10 2006 045 282 A1, the entire disclosed content of which is incorporated in the present application by reference.

The resulting integral asymmetric structure arises from a combination of two different thermodynamic processes. The method can be performed for block copolymers with different polymer components that separate in a solvent by means of microphase separation. For example, in DE 10 2006 045 282 A1, the integral asymmetric structure of the block copolymer membranes is disclosed with reference to the example of a membrane based on PS-b-P4VP (polystyrene-b-poly-4-vinylpyridine). Similar results have been achieved with the chemically significantly different PS-b-P2VP (polystyrene-b-poly-2-vinylpyridine) and PS-b-PEO (polystyrene-b-polyethylene oxide). The results achieved with PS-b-P2VP are published in A. Jung et al. (2012), “Structure Formation of Integral Asymmetric Composite Membranes of Polystyrene-block-poly(2-vinylpyridine) on a Nonwoven”, Macromol. Mater. Eng. doi: 10.1002/mame.201100359. The results with PS-b-PEO are disclosed in German application No. 10 2012 207 338.8 by the applicant.

This technical teaching was further developed in international application WO 2011/098851 A1 by Peinemann et al., and its disclosed content is also fully incorporated in the present application by reference. The application proposes adding a metal salt to the casting solution which forms complexes with at least one of the polymer blocks of the block copolymer. The metal salts are strong complexing agents, namely transition metals such as copper, cobalt, nickel, iron, inter alia. A copolymer consisting of polystyrene (PS) and poly-4-vinylpyridine (P4VP) with added copper acetate is cited as an example.

The polystyrene functions as a matrix former, whereas the P4VP forms the pores in the precipitated membrane. The copper forms complexes with the pyridine groups of P4VP, the hydrophilic component of the block copolymer. During the evaporation of the solvent and during the phase inversion process, the complex stabilizes the pore structure of the surface.

The transition metal complexes are comparatively strong and difficult to wash out so that, over the course of time, biologically harmful transition metal ions are washed out of used membranes, which renders the membranes useless for biological applications and especially for health-relevant applications.

### SUMMARY

It is therefore the object of the present invention to provide a method for producing a polymer membrane, as well as the corresponding polymer membrane, by means of which biological applications can be safely performed on an industrial scale. Controllability of the pore size is also desirable in some cases.

The underlying object of the invention is achieved by a method for producing a polymer membrane with an isoporous separation-active layer, especially an ultrafiltration membrane or nanofiltration membrane with the following steps:
producing a casting solution having at least one solvent in which are dissolved at least one amphiphilic block copolymer with at least two different polymer blocks and at least one carbohydrate,
spreading out the casting solution to form a film,
allowing a near-surface part of the at least one solvent to evaporate during a waiting time, and
precipitating a membrane by immersing the film in a precipitation bath comprising at least one non-solvent for the block copolymer.

In contrast to the method according to WO 2011/098851 A1, carbohydrates and not complex-forming metal salts are added to the casting solution. These substances are more biologically compatible than the transition metals and their salts. When used in the method according to the invention, the carbohydrates manifest a significant stabilization of the isoporous, separation-active surface during phase inversion by immersion in a precipitation bath.

The supportive effect of the carbohydrates during phase separation is attributed to the fact that carbohydrates can form hydrogen bridge bonds with the hydrophilic block of the block copolymers. The viscosity of the polymer solution is significantly increased by the hydrogen bridges so that a lower concentration of the block copolymers in the solution is sufficient to form the structure according to the invention with the isoporous separation-active layer.

Using carbohydrates to improve the membrane structure overcomes the problem of continuous, subsequent release of poisonous metal ions by the membrane during its use. Since carbohydrates are nonpoisonous, the use of the membrane for medical or respectively biologically relevant processes is harmless.

Adding carbohydrates to the block copolymer solution increases its viscosity which leads to reduced penetration of said solution into the porous carrier. The casting solution may hence not enter the support fleece as easily. This also makes it possible to work with lower concentrations of block copolymers in the casting solution which leads to savings in material of the relatively expensive block copolymers. The invention furthermore replaces expensive transition metal salts with much more economical carbohydrates. Cleaning the produced membrane is unproblematic. The arising wastewater in membrane production is not contaminated with heavy metals.

Some membranes produced according to the invention furthermore manifest adjustable pore sizes. Hence by changing the pH of a solution flowing through the pores, the flow of water through the membrane can be adjusted over a large range. Control by means of the pH works when the pore-forming polymer block reacts to changes in the pH, e.g., expands or contracts, and accordingly narrows or expands the pores.

The parameters of the method are preferably optimized depending on the selected educts. The casting solution is preferably stirred before casting until the block copolymer has dissolved, in particular for a duration up to 48 hours. The casting solution is preferably applied onto a carrier material, preferably onto a nonwoven fleece material. The evaporation time is preferably between 1 and 120 seconds, or preferably between 1 and 30 seconds. Immersion in the precipitation bath is preferably for a duration between 1 minute and 1 hour, preferably between 5 and 10 minutes. After being removed from the precipitation bath, the membrane is advantageously dried, preferably for a duration of 12 to 48 hours, preferably in the air and/or in a vacuum oven in order to remove residual solvent. A long drying time is preferred.

It is particularly preferable when the carbohydrate is saccharose, D(+) glucose, D(−) fructose and/or cyclodextrine, especially α-cyclodextrine. D(+) glucose is also called grape sugar, D(−) fructose is called fruit sugar, and saccharose is called table sugar. These carbohydrates manifest a strong stabilization effect on the isoporous separation-active surface.

Preferably, the at least one block copolymer comprises two or three polymer blocks A, B and possibly C which are different from each other with the configuration A-B, A-B-A or A-B-C, wherein each of the polymer blocks are selected from the group of polystyrene, poly-4-vinylpyridine, poly-2-vinylpyridine, polybutadiene, polyisoprene, poly(ethylene-stat-butylene), poly(ethylene-alt-propylene), polysiloxane, polyalkyleneoxide, poly-ε-caprolactone, polylactide, polyalkylmethacrylate, polymethacrylic acid, polyalkylacrylate, polyacrylic acid, polyhydroxyethylmethacrylate, polyacrylamide or poly-N-alkylacrylamide, polysulfone, polyaniline, polypyrrole, polytriazole, polyvinylimidazole, polytetrazole, polyethylenediamine, polyvinylalcohol, polyvinylpyrrolidone, polyoxadiazole, polyvinylsulfonic acid, polyvinylphosphonic acid or polymers with quaternary ammonium groups. These polymers form a selection of hydrophilic and hydrophobic polymers that can be used as polymer blocks in the amphiphile block copolymer.

The block copolymers and polymer blocks preferably have a low polydispersity, especially less than 1.5, especially less than 1.2. This supports the self-organization of the block copolymers and microphase formation.

In addition or alternatively, the polymer lengths of the at least two polymer blocks of amphiphilic block copolymer are advantageously selected relative to each other such that self-organization in the solvent leads to the formation of a spherical or cylindrical micelle structure in the solvent, in particular a length ratio between 2:1 and approximately 10:1, in particular between approximately 3:2 and 6:1. These length ratios of the majority component to the minority component of the block copolymers lead to the desired micelle structure, i.e., the inclusion of individual spherical micelles of the minority component in the bulk of the majority component, or to cylindrical micelle structures in which the minority component forms the cylinders inside the bulk of the majority component.

Preferably, the block copolymer has a molecular weight between 100 kDa and 600 kDa, in particular between 130 kDa and 250 kDa. Within this range, the pore size is particularly finely adjustable by selecting the molecular weight.

Advantageously, at least one homopolymer and/or copolymer is dissolved in the solution, the homopolymer and/or copolymer corresponding to a polymer block of the amphiphilic block copolymer with an equivalent or deviating polymer length. In this manner, the pore structure of the isoporous separation layer can be very finely adjusted, especially with regard to the diameter of the pores and the spacing of the pores. For example, adding the polymer component which forms the pores in the block copolymer causes the average pore diameter to increase, whereas adding homopolymers of the matrix-forming component, which is normally the majority component of the block copolymer, causes the distance between the pores to increase. The amount of homopolymer should not be so great that the micelles cannot connect to form permeable pores.

It is advantageous to use several solvents, the polymer blocks of the block copolymer being soluble to varying degrees in the different solvents, and the solvents being volatile to varying degrees. The varying volatility is exploited to selectively harden the different polymer blocks during evaporation. Preferably, dimethylformamide, and/or dimethylacetamide, and/or N-methylpyrrolidone, and/or dimethylsulfoxide, and/or tetrahydrofurane and/or dioxane, or a mixture of two or more of the solvents, are used as the solvent.

The weight percentage of the polymer is preferably between 10% by weight and 40% by weight, in particular between 15% by weight and 25% by weight of the solution. Furthermore the percentage weight of the carbohydrate is preferably between 0.1% by weight and 5% by weight, in particular between 0.5% by weight and 2% by weight of the solution.

The waiting time is preferably between 5 seconds and 60 seconds, in particular less than 25 seconds, in particular up to 15 seconds.

Water and/or methanol and/or ethanol and/or acetone is preferably used as the precipitation bath.

Advantageously, additives that engage in specific interactions with the water-soluble polymer block are introduced into the casting solution, especially p-nitrophenol, hydroquinone and/or rucinol. The weight percentage of these additives is preferably between 0.1% by weight and 5% by weight, especially between 0.5% by weight and 2% by weight of the solution.

A more stable membrane is obtained when the casting solution is cast onto a carrier material, especially on a nonwoven fleece material. Increasing the viscosity by introducing the carbohydrates has the further advantage that the casting solution does not penetrate the fleece material as much as a casting solution without carbohydrates. This saves material.

Furthermore, the carbohydrate is preferably washed out after precipitating the membrane.

The underlying object of the invention is also achieved by a polymer membrane with an isoporous separation-active layer, especially an ultrafiltration membrane or nanofiltration membrane, produced or producible according to a method according to the invention described above, especially with a ratio of the maximum pore diameter to the minimum pore diameter of less than 3. This membrane according to the invention has the aforementioned properties.

Furthermore, the underlying object of the invention is also achieved by a filtration module, especially an ultrafiltration module or nanofiltration module with an above-described polymer membrane according to the invention, as well as by using an above-described polymer membrane according to the invention, or an above-described filtration module according to the invention for purifying water or biological macromolecules or active ingredients. Using the corresponding polymer membrane or filtration module with the polymer membrane according to the invention has the advantage that the membrane does not lose any toxic substances which collect in the filtered medium that is applied to a biological function.

Further features of the invention will become apparent from the description of the embodiments according to the invention together with the claims and the included drawings. Embodiments according to the invention can fulfill individual features or a combination of several features.

### BRIEF DESCRIPTION OF THE DRAWINGS

FIG. 1 illustrates scanning electron microscopic (SEM) images of hand-cast membranes.

FIG. 2 illustrates scanning electron microscopic (SEM) images of hand-cast membranes.

FIG. 3 illustrates scanning electron microscopic (SEM) images of hand-cast membranes.

FIG. 4 illustrates scanning electron microscopic (SEM) images of hand-cast membranes.

FIG. 5 illustrates scanning electron microscopic (SEM) images of hand-cast membranes.

FIG. 6 illustrates scanning electron microscopic (SEM) images of hand-cast membranes.

FIG. 7 illustrates scanning electron microscopic (SEM) images of membranes cast by a membrane casting machine.

FIG. 8 illustrates scanning electron microscopic (SEM) images of membranes cast by a membrane casting machine.

FIG. 9 illustrates scanning electron microscopic (SEM) images of membranes cast by a membrane casting machine.

FIG. 10 illustrates scanning electron microscopic (SEM) images of membranes cast by a membrane casting machine.

FIG. 11 illustrates scanning electron microscopic (SEM) images of membranes cast by a membrane casting machine.

FIG. 12 illustrates scanning electron microscopic (SEM) images of membranes cast by a membrane casting machine.

FIG. 13 illustrates scanning electron microscopic (SEM) images of membranes cast by a membrane casting machine.

FIG. 14 illustrates scanning electron microscopic (SEM) images of membranes cast by a membrane casting machine with a lower molecular weight than the previous membranes.

FIG. 15 illustrates scanning electron microscopic (SEM) images of membranes cast by a membrane casting machine with a lower molecular weight than the previous membranes.

FIG. 16 illustrates scanning electron microscopic (SEM) images of membranes cast by a membrane casting machine with a lower molecular weight than the previous membranes.

### DETAILED DESCRIPTION

The invention will be explained below with reference to a few examples of membranes according to the invention compared with membranes not according to the invention.

In the following, a few abbreviations will be used. Accordingly, “PS” stands for polystyrene, “P4VP” stands for poly-4-vinylpyridine, “THF” stands for tetrahydrofuran, and “DMF” stands for dimethylformamide. Block copolymers are for example identified as “PS₈₃-b-P4VP₁₇ 190 kDa”. This means a block copolymer with an overall molecular weight of 190 kDa with a majority component of polystyrene which constitutes 83% of the overall weight of the block copolymer, and with a minority component of poly-4-vinylpyridine which constitutes 17%. A solvent mixture of THF/DMF 35/65 consists for example of 35% by weight THF and 65% by weight DMF.

### EXAMPLE 1

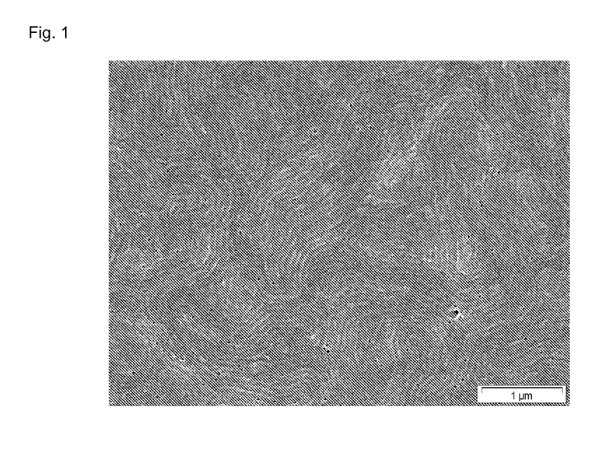

In a first test series, the results of which are shown in FIGS. 1 to 6, membranes based on a solution of 22% by weight PS₈₃-b-P4VP₁₇ 190 kDa in the solvent mixture THF/DMF 35/65 are cast manually (“handcasting”). The height of the doctor blade was 200 μm in each case, and 20° C. H₂O was used as the phase inversion bath.

The evaporation time and added carbohydrates were varied.

### Comparative Example 1

The first comparative example relates to a membrane which was handcast with an evaporation time of 15 seconds without added carbohydrates under the conditions cited under example 1 above.

FIG. 1 shows an SEM image of the surface of the membrane according to comparative example 1. This membrane does not manifest any significant porosity.

### EXAMPLE 1a

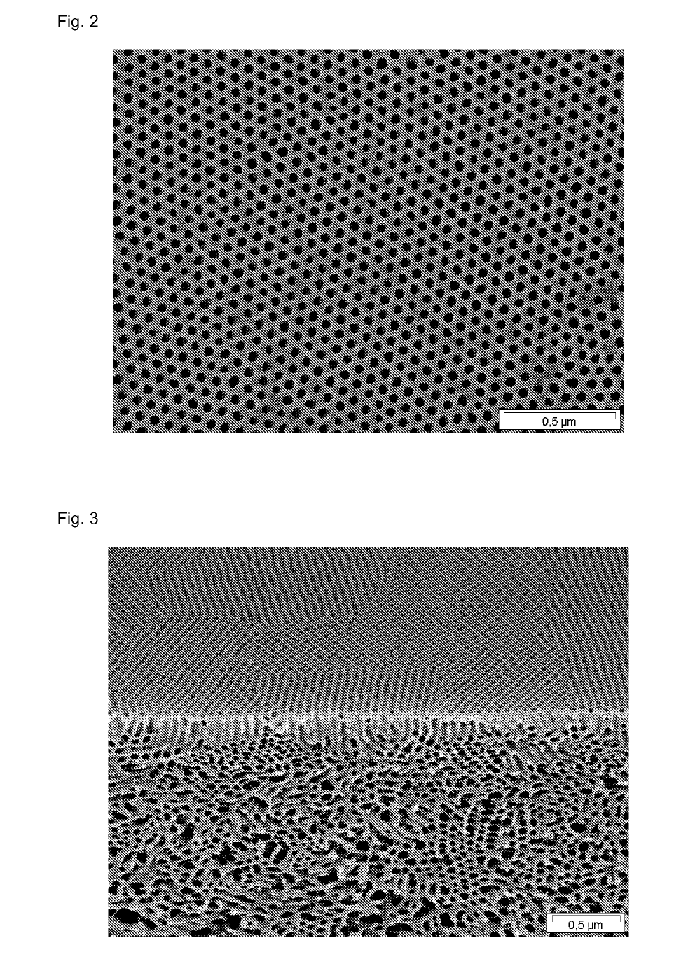

FIGS. 2 and 3 show SEM images of the surface (FIG. 2) and the transverse fracture (FIG. 3) of a handcast membrane, otherwise under the same conditions, with 0.5% by weight α-cyclodextrine added to the solution (example 1a). It has the integral asymmetrical structure according to the invention in which an isoporous microphase morphology that was formed based on the self-organization of the polymer blocks of the block copolymers transitions directly into the typical sponge-like structure of the solvent-induced phase-separated polymer membrane.

### EXAMPLE 1b

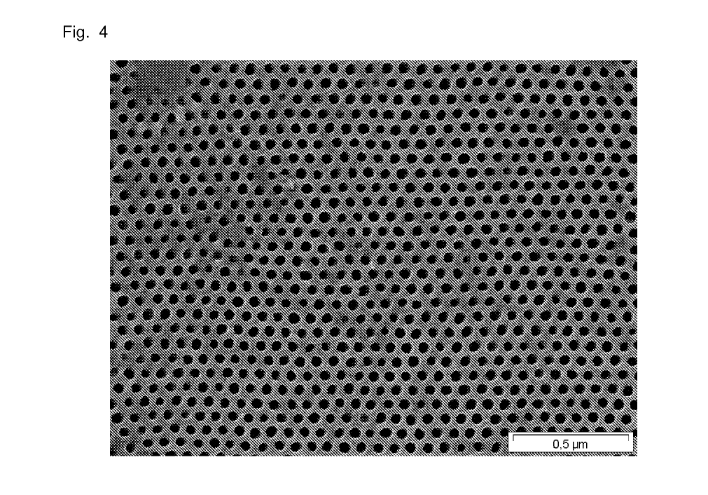

The membrane shown in FIG. 4 (example 1b) with a surface that also has the microphase-separated isoporous pore distribution was generated as in comparative example 1, however with an evaporation time of 10 seconds and the addition of 1% by weight D(+) glucose to the solution.

### EXAMPLE 1c

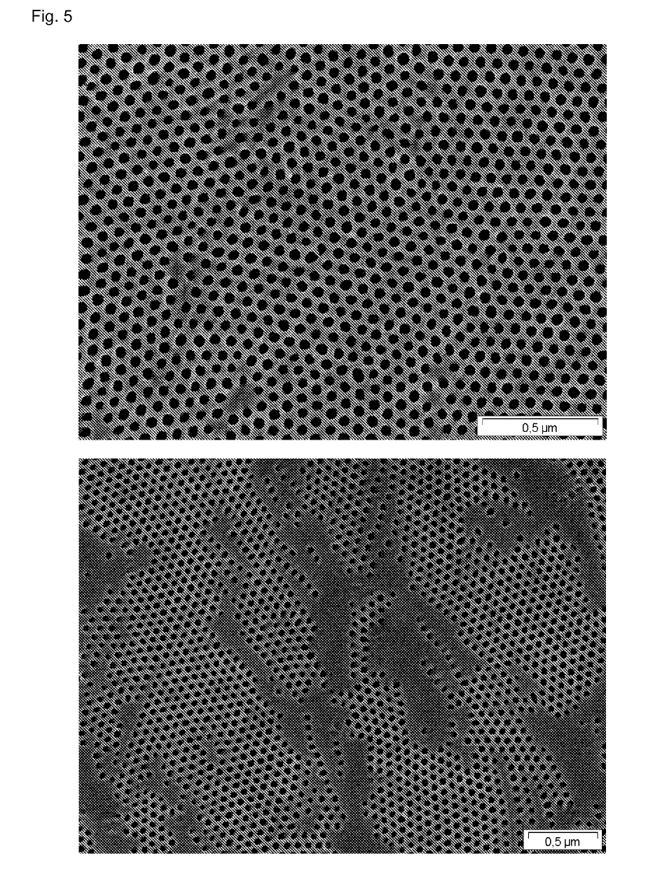

Under the conditions of comparative example 1, a membrane was generated with an evaporation time of 8 seconds by adding 1% by weight table sugar to the solution (example 1c). The top and bottom part of FIG. 5 show two areas of the surface of the membrane generated in this manner. The majority has the isoporous surface according to the invention, whereas a smaller portion is not completely developed in some areas, and there is no porosity in these sections. This is true of significantly less than 30% of the surface of the relevant areas.

### EXAMPLE 1d

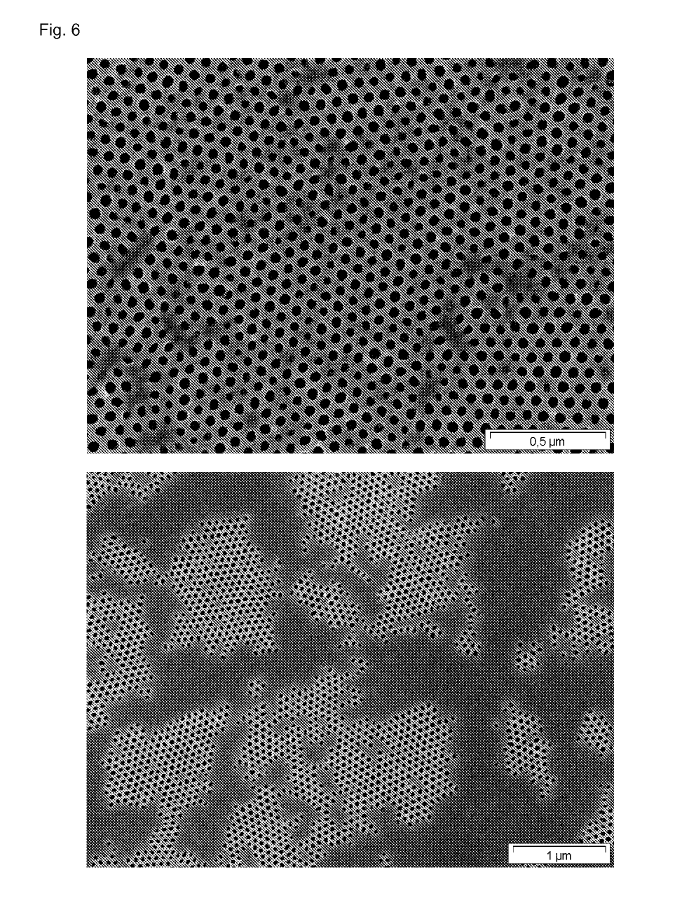

Under the conditions of comparative example 1, a membrane is generated with an evaporation time of 12 seconds by adding 1% by weight D(−) fructose to the solution (example 1d). The top and bottom part of FIG. 6 show two areas of the surface of the membrane generated in this manner. The majority has the isoporous surface according to the invention, whereas a smaller portion is not completely developed in some areas, and there is no porosity in these sections. This is true of approximately 50% of the surface of the relevant areas.

### EXAMPLE 2

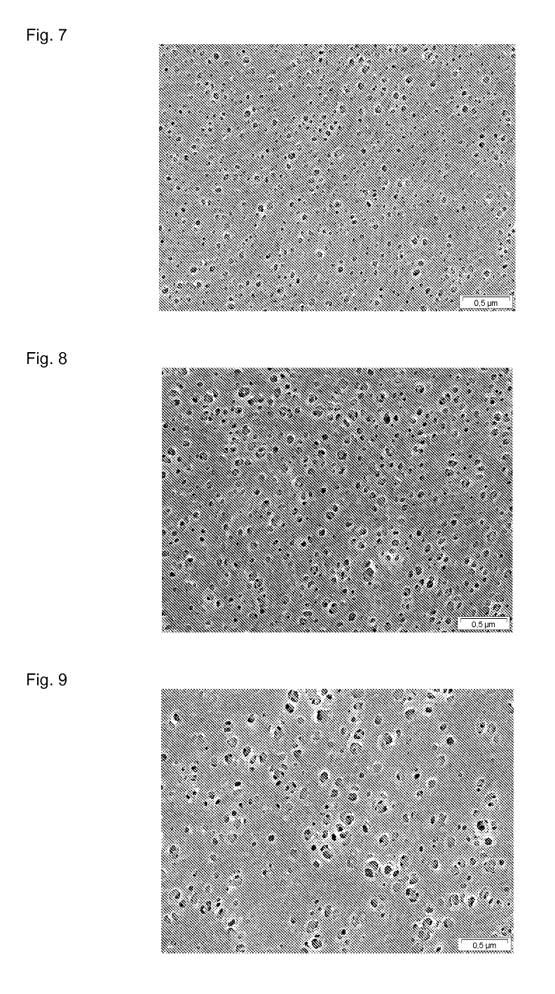

In a second test series according to FIGS. 7 to 13, the same solution was used, that is, 22% by weight PS₈₃-b-P4VP₁₇ 190 kDa in the solvent mixture THF/DMF 35/65. The height of the doctor blade was again 200 μm in each case, and 20° C. H₂O was used as the phase inversion bath.

In contrast to the first test series (comparative example 1 and examples 1a to 1d), the membranes were however not cast by hand but rather by means of a membrane casting machine.

### Comparative Example 2

The second comparative example relates to a membrane according to example 2 that was cast with a membrane casting machine under different evaporation times between 6 and 15 seconds without adding carbohydrates. The evaporation times for FIGS. 7, 8 and 9 were 6, 10 and 15 seconds. As the evaporation time increases from FIG. 7 to FIG. 9, the size of the pores increases; however, they do not manifest the desired isoporous distribution.

### EXAMPLE 2a

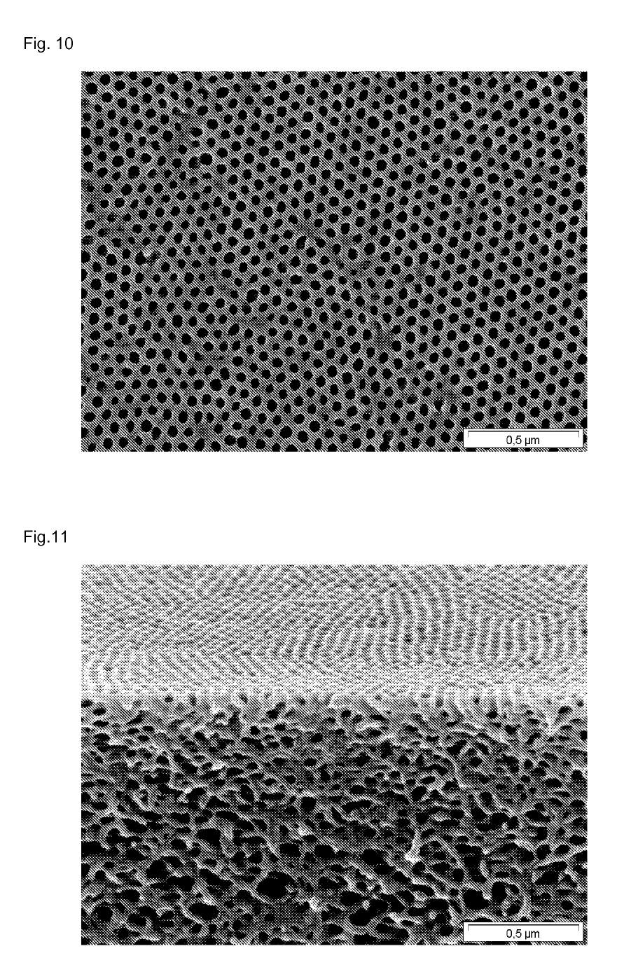

FIGS. 10 and 11 show SEM images of the surface (FIG. 10) and the transverse fracture (FIG. 11) of a machine-cast membrane, otherwise under the same conditions as in comparative example 2, with an evaporation time of 5 seconds and with 1% by weight α-cyclodextrine added to the solution (example 2a). It has the integral asymmetrical structure according to the invention in which an isoporous microphase morphology that was formed based on the self-organization of the polymer blocks of the block copolymers transitions directly into the typical sponge-like structure of the solvent-induced phase-separated polymer membrane.

### EXAMPLE 2b

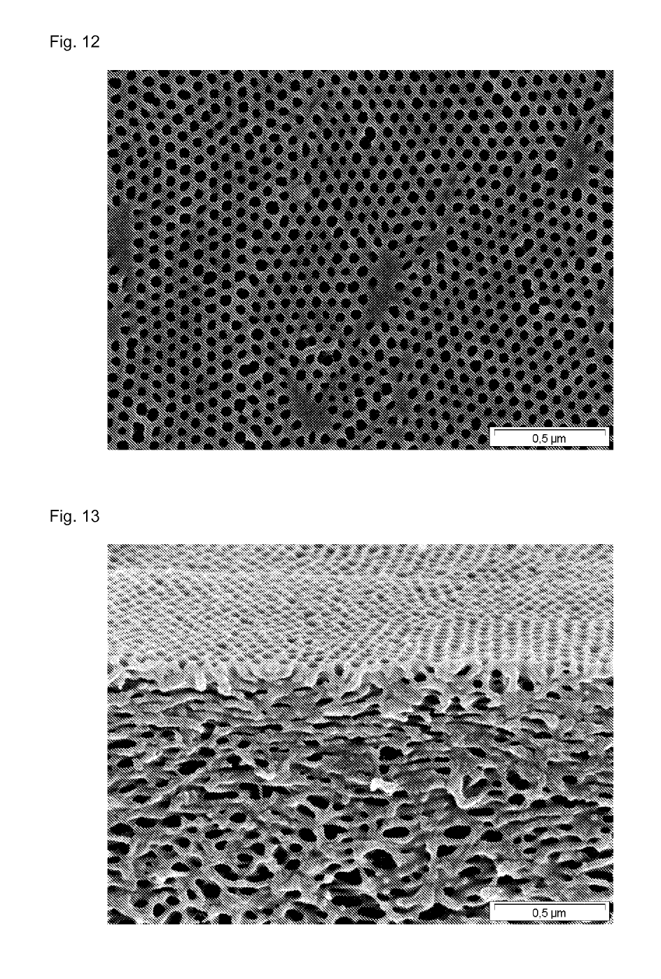

FIGS. 12 and 13 show SEM images of the surface (FIG. 12) and the transverse fracture (FIG. 13) of a machine-cast membrane, otherwise under the same conditions as in comparative example 2, with an evaporation time of 11 seconds and with 1.5% by weight D(+) glucose added to the solution (example 2b). It has the integral asymmetrical structure according to the invention in which an isoporous microphase morphology that was formed based on the self-organization of the polymer blocks of the block copolymers with a few defects transitions directly into the typical sponge-like structure of the solvent-induced phase-separated polymer membrane.

### EXAMPLE 3

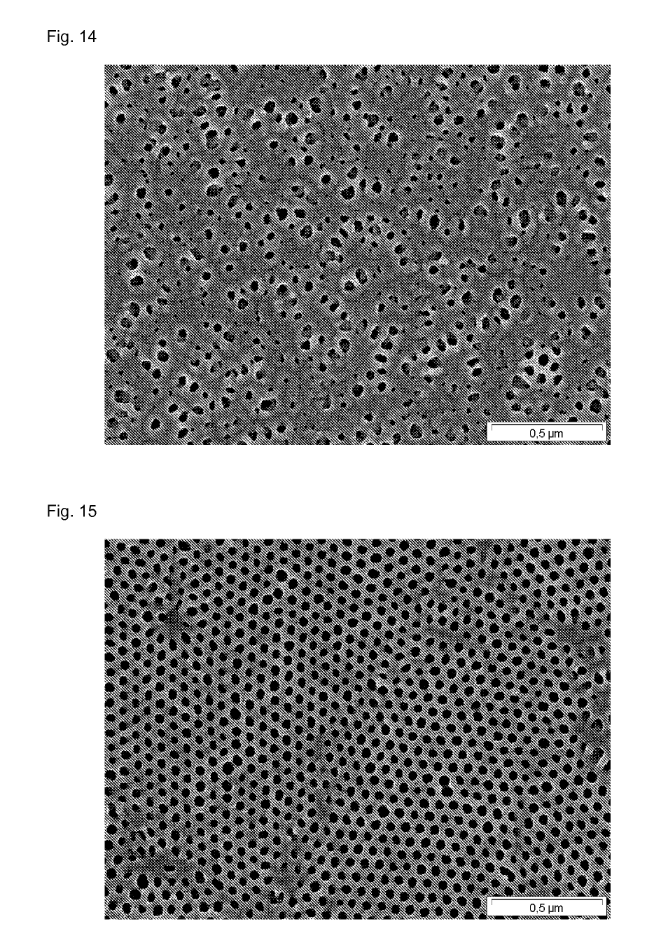

In a third test series, the results of which are shown in FIGS. 14 to 16, a solution was used with a copolymer with a lower molecular weight. The solution was a solution with 22% by weight PS₈₁-b-P4VP₁₉ 160 kDa in the solvent mixture THF/DMF 40/60. The height of the doctor blade was again 200 μm in each case, and 20° C. H₂O was used as the phase inversion bath. In this test series, an evaporation time of 5 seconds was always used. As in the second test series (example 2), the membranes were cast by means of a membrane casting machine.

### Comparative Example 3

The third comparative example relates to a membrane according to example 3 that was cast without adding carbohydrates with a membrane casting machine. Its surface is shown in FIG. 14. The visible pores do not have the desired isoporous distribution.

### EXAMPLE 3a

FIG. 15 shows an SEM image of the surface of a machine-cast membrane, otherwise under the same conditions as in comparative example 3, with the addition of 1.5% by weight D(+) glucose to the solution (example 3a). It has the integral asymmetrical structure according to the invention in which an isoporous microphase morphology that was formed based on the self-organization of the polymer blocks of the block copolymers with a few defects transitions directly into the typical sponge-like structure of the solvent-induced phase-separated polymer membrane.

### EXAMPLE 3b

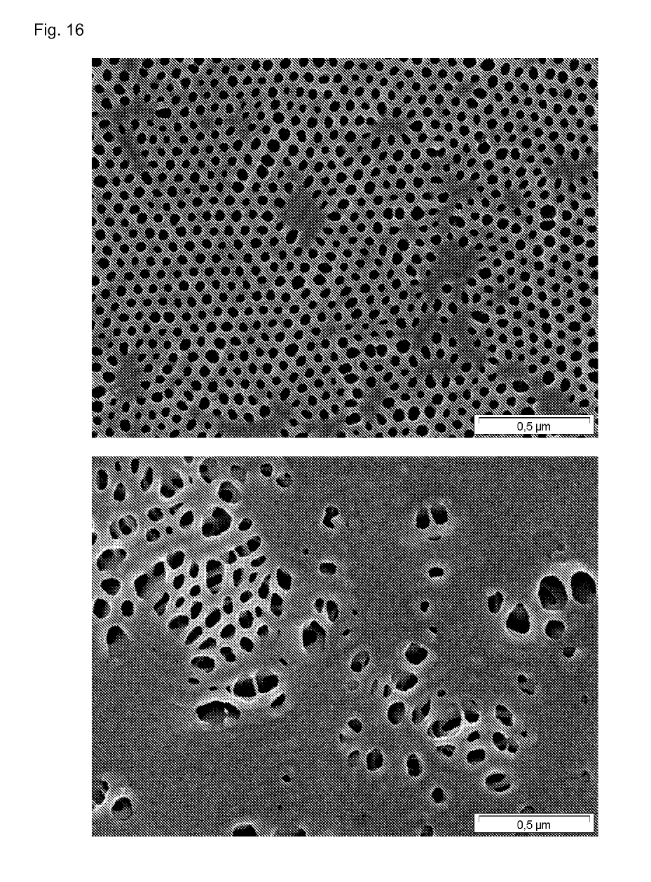

FIG. 16 shows two SEM images of different areas of a surface of a membrane that was produced according to example 3a, however with the addition of 2% by weight D(+) glucose, the block copolymer concentration in the solution only being 20% by weight instead of 22% by weight. Mainly the well-ordered areas shown above in FIG. 16 are present, whereas small portions of the surface manifest the inadequately ordered structure in the bottom picture in FIG. 16.

This illustrates that a reduction of the polymer concentration is possible, and fine adjustments of the production conditions can lead to a further improvement while simultaneously saving expensive copolymer.

All named features, including those to be taken from the drawings alone, and individual features, which are disclosed in combination with other features, are considered individually and in combination as essential to the invention. Embodiments according to the invention can be realized by the individual features, or a combination of several features.

1. A method for producing a polymer membrane with an isoporous, separation-active layer, especially an ultrafiltration membrane or nanofiltration membrane comprising the following steps:
producing a casting solution having at least one solvent in which are dissolved at least one amphiphilic block copolymer with at least two different polymer blocks and at least one carbohydrate,
spreading out the casting solution to form a film,
allowing a near-surface part of the at least one solvent to evaporate during a waiting time, and
precipitating a membrane by immersing the film in a precipitation bath comprising at least one non-solvent for the block copolymer.

2. The method according to claim 1, wherein the carbohydrate is saccharose, D(+) glucose (=grape sugar), D(−) fructose (=fruit sugar) and/or cyclodextrine, especially α-cyclodextrine.

3. The method according to claim 1, wherein the at least one block copolymer comprises two or three polymer blocks A, B and possibly C which are different from each other with the configuration A-B, A-B-A or A-B-C, wherein each of the polymer blocks are selected from the group of polystyrene, poly-4-vinylpyridine, poly-2-vinylpyridine, polybutadiene, polyisoprene, poly(ethylene-stat-butylene), poly(ethylene-alt-propylene), polysiloxane, polyalkyleneoxide, poly-ε-caprolactone, polylactide, polyalkylmethacrylate, polymethacrylic acid, polyalkylacrylate, polyacrylic acid, polyhydroxyethylmethacrylate, polyacrylamide, poly-N-alkylacrylamide, polysulfone, polyaniline, polypyrrole, polytriazole, polyvinylimidazole, polytetrazole, polyethylenediamine, polyvinylalcohol, polyvinylpyrrolidone, polyoxadiazole, polyvinylsulfonic acid, polyvinylphosphonic acid or polymers with quaternary ammonium groups.

4. The method according to claim 1, wherein the block copolymers and polymer blocks have a low polydispersity, less than 1.5, and less than 1.2, and/or that the polymer lengths of the at least two polymer blocks of the amphiphilic block copolymer are selected relative to each other such that self-organization in the solvent leads to the formation of a spherical or cylindrical micelle structure in the solvent, a length ratio between approximately 2:1 and approximately 10:1, and between approximately 3:1 and 6:1.

5. The method according to claim 1, wherein the block copolymer has a molecular weight between 100 kDa and 600 kDa, and between 130 kDa and 250 kDa.

6. The method according to claim 1, wherein that at least one homopolymer and/or copolymer is dissolved in the solution, the homopolymer and/or copolymer corresponding to a polymer block of the amphiphilic block copolymer with an equivalent or deviating polymer length.

7. The method according to claim 1, wherein several solvents are used, the polymer blocks of the block copolymer soluble in the different solvents to varying degrees, and the solvents being volatile to varying degrees, wherein especially dimethylformamide, and/or dimethylacetamide, and/or N-methylpyrrolidone, and/or dimethylsulfoxide, and/or tetrahydrofurane and/or dioxane, or a mixture of two or more of the solvents, are used as the solvent.

8. The method according to claim 1, wherein the weight percentage of the polymer is between 10% by weight and 40% by weight, and in particular between 15% by weight and 25% by weight, of the solution, and/or the percentage weight of the carbohydrate is between 0.1% by weight and 5% by weight, in particular between 0.5% by weight and 2% by weight, of the solution.

9. The method according to claim 1, wherein the waiting time is between 5 seconds and 60 seconds, in particular less than 25 seconds, in particular up to 15 seconds.

10. The method according to claim 1, wherein water and/or methanol and/or ethanol and/or acetone are used as the precipitation bath.

11. The method according to claim 1, wherein the casting solution is cast on a carrier material, especially on a nonwoven fleece material.

12. The method according to claim 1, wherein the carbohydrate is washed out after precipitating the membrane.

13. A polymer membrane with an isoporous, separation-active layer, especially an ultrafiltration membrane or nanofiltration membrane, produced or producible according to the method of claim 1, with a ratio of maximum pore diameter to minimum pore diameter of less than 3.

14. A polymer membrane according to claim 13 for use in purifying water or biological macromolecules or active ingredients.

15. A filtration module, in particular an ultrafiltration module or nanofiltration module, with a polymer membrane according to claim 13.

16. A filtration module according to claim 15 for use in purifying water or biological macromolecules or active ingredients.
